(19) United States
(12) Patent Application Publication
(10) Pub. No.: US 2009/0041258 A1
(43) Pub. Date: Feb. 12, 2009

(54) Noise reduction apparatus

(76) Inventor: Tatsumi Nakajima, Chiba (JP)

Correspondence Address: MCCRACKEN & FRANK LLP, 311 S. WACKER DRIVE, SUITE 2500, CHICAGO, IL, 60606, US

(21) Appl. No.: 11/794,994

(22) PCT Filed: Nov. 12, 2004
(86) PCT No.: PCT/JP04/16862

§ 371 Date: Jul. 10, 2007

(51) Int. Cl. G10K 11/16; G10K 11/178

(52) U.S. Cl. 381/71.2

(57) ABSTRACT

Effective reduction is made of direct sound or diffracted sound of a noise propagating from plural directions. Three microphones (18ₖ₋₁, 18ₖ, 18ₖ₊₁) are disposed and: noise is detected by each of the microphones; delay signals are generated by delaying plural times a signal that has been output from 2 of the microphones (18ₖ₋₁, 18ₖ₊₁); the output signal from the remaining microphone (18ₖ) is added to 2 of the delayed signals and input to respective speakers of a speaker unit; a control sound is output from the speaker unit in 3 directions (L, C, R); and reduction is made of direct sound or diffracted sound of a noise propagating from each of the directions.

### TECHNICAL FIELD

The present invention relates to a noise reducing device, and in particular to a noise reducing device for reducing, at the outside of a sound barrier, noise that is generated when moving bodies move, for example, noise that has been generated by vehicles traveling on an expressway.

### BACKGROUND ART

Conventionally known in which speakers are disposed at the top edge of the sound insulation barrier and along the top edge of the sound insulation barrier, and noise that has been diffracted from the sound insulation barrier is suppressed by sound waves of opposite phase being emitted from the speakers.

Also, a noise reducing device is known in which, when suppressing noise using a control sound, linear sound source arrays of speaker units including plural arrayed speakers are disposed along the top edge of a sound barrier, and by using filter coefficients that have been computed by explicit methods and an acoustic signal of the noise that has been detected by a microphone, noise is reduced at a control point by emitting a control sound of the opposite phase to diffracted sound of the noise.

Furthermore, an ASE system manufactured by Mitsubishi Heavy Industries is known as a practical method of active control using a linear array sound source for reduction of sound barrier diffracted sound from a sound source, sound passing through the interior of a continuously disposed sound barrier. The ASE system is one of localized control that assumes that the control points are points at the apex of a sound barrier, and since the ASE system units function independently, the control area may be extended by disposing a series of ASE system units, and the problem of mutual interference between control sounds does not occur.

However, in the above described technology, since linear array sound sources such as speakers with speakers arranged in a straight line are used, then the control sound is emitted from each of the speakers simultaneously, sound emission only has a strong sound pressure level in a single direction. Due to this, when there are moving noise sources, such as the noise from vehicles traveling on an expressway, since noise propagates to the noise reduction control points from various directions, it is difficult to carry out effective noise reduction.

Patent Publication 1: Japanese Patent Application No. H9-54593

Patent Publication 2: WO03/030147 A1

### DISCLOSURE OF THE INVENTION

### Problem to be Solved by the Invention

The problem to be solved by the invention is that effective noise reduction of noise propagating from various directions cannot be made.

### Method of Solving the Problem

The first invention is a noise reducing device including a speaker unit, a first microphone, a second microphone, first control signal output means, second control signal output means and control means. The speaker unit includes plural speakers arrayed so that the direction of sound emission therefrom faces in a predetermined direction. The first microphone is disposed so as to correspond to the speaker unit, and collects the sound of a noise and outputs a first acoustic signal corresponding to the sound of the noise that has been collected. The second microphone is disposed in a position that is separated in the speaker array direction from the disposed position of the first microphone, and it collects the sound of a noise and outputs a second acoustic signal corresponding to the sound of the noise that has been collected. The first control signal output means outputs, on the basis of the first acoustic signal, a first control signal for emitting a control sound that reduces the direct sound or the diffracted sound of the noise that has been collected by the first microphone. The second control signal output means outputs, on the basis of the second acoustic signal, plural second control signals for emitting a control sound that reduces the direct sound or the diffracted sound of the noise that has been collected by the second microphone, the plural second control signals having each been delayed respectively by incremental predetermined time periods. The control means controls such that the first control signal is input simultaneously to the respective speakers, and such that the second control signals are input with gradually increasing delay times from the speaker at one end of the speaker unit toward the speaker at the other end of the speaker unit.

The second invention is a noise reducing device including a speaker unit, a first microphone, a second microphone, a third microphone, first control signal output means, second control signal output means, third control signal output means and control means. The speaker unit includes plural speakers arrayed so that the direction of sound emission therefrom faces in a predetermined direction. The first microphone is disposed so as to correspond to the speaker unit, and collects the sound of a noise and outputs a first acoustic signal corresponding to the sound of the noise that has been collected. The second microphone is disposed in a position that is separated in the speaker array direction from the disposed position of the first microphone, and collects the sound of a noise and outputs a second acoustic signal corresponding to the sound of the noise that has been collected. The third microphone is disposed in a position that is separated in the speaker array direction from the disposed position of the first microphone in the opposite direction to that of the second microphone, and collects the sound of a noise and outputs a third acoustic signal corresponding to the sound of the noise that has been collected. The first control signal output means outputs, on the basis of the first acoustic signal, a first control signal for emitting a control sound that reduces the direct sound or the diffracted sound of the noise that has been collected by the first microphone. The second control signal output means outputs, on the basis of the second acoustic signal, plural second control signals for emitting a control sound that reduces the direct sound or the diffracted sound of the noise that has been collected by the second microphone, the plurality of second control signals having each been delayed respectively by incremental predetermined time periods. The third control signal output means outputs, on the basis of the second acoustic signal, plural third control signals for emitting a control sound that reduces the direct sound or the diffracted sound of the noise that has been collected by the third microphone, the plurality of third control signals having each been delayed respectively by incremental predetermined time periods. The control means controls such that the first control signal is input simultaneously to the respective speakers, such that the second control signals are input with gradually increasing delay times from the speaker at one end of the speaker unit toward the speaker at the other end of the speaker unit, and such that the third control signals are input with gradually decreasing delay times from the speaker at the one end of the speaker unit toward the speaker at the other end of the speaker unit.

The third invention is a noise reducing device including plural speaker unit, plural microphones, first control signal output means, second control signal output means, third control signal output means and control means. The plural speaker units each include plural speakers arrayed so that the direction of sound emission therefrom faces in a predetermined direction. The plural microphones are disposed so as to correspond to the respective speaker units, and collecting the sound of a noise and outputting an acoustic signal corresponding to the sound of the noise that has been collected. The first control signal output means are provided to correspond with each of the respective speaker units, and output, on the basis of the acoustic signal that has been output from a first corresponding microphone that corresponds to the corresponding speaker unit, a first control signal for emitting a control sound that reduces the direct sound or the diffracted sound of the noise that has been collected by the first corresponding microphone. The second control signal output means are provided to correspond with each of the respective speaker units, and output, on the basis of the acoustic signal that has been output from a second corresponding microphone that corresponds to one of the speaker units that is adjacent to the corresponding speaker unit, a second control signal for emitting a control sound that reduces the direct sound or the diffracted sound of the noise that has been collected by the second corresponding microphone. The third control signal output means are provided to correspond with each of the respective speaker units, and output, on the basis of the acoustic signal that has been output from a third corresponding microphone that corresponds to the other one of the speaker units that is adjacent to the corresponding speaker unit, a third control signal for emitting a control sound that reduces the direct sound or the diffracted sound of the noise that has been collected by the third corresponding microphone. The control means is provided so as to input the signals to the respective speaker units, and controls such that the first control signal is input simultaneously to the respective speakers of the speaker units to which the signals are being input, such that the respective second control signals are input to the speakers of the speaker unit to which the signals are being input with gradually increasing delay times from the speaker at one end of the speaker unit to which the signals are being input toward the speaker at the other end thereof, and such that the third respective control signals are input to the speakers of the speaker unit to which the signals are being input with gradually decreasing delay times from the speaker at the one end of the speaker unit to which the signals are being input toward the speaker at the other end thereof.

That is to say, the main feature of the present invention is having at least two types of control sound, control sound that is emitted simultaneously from each of the speakers of a speaker unit, and control sound that is emitted by each of the speakers delayed by increments of a predetermined amount, or in other words plural control sounds that have different propagation directions from each other.

### EFFECT OF THE INVENTION

In the noise reducing device of the present invention, since control sound is emitted in plural directions from speaker unit(s), effective noise reduction may be made even for noise propagated from plural directions.

### BRIEF DESCRIPTION OF THE DRAWINGS

FIG. 1 is a lateral view of a noise reducing device in a state of being mounted to a sound barrier (first exemplary embodiment).

FIG. 2 is a lateral view of a noise reducing device in a state of being mounted to a sound barrier (second exemplary embodiment).

FIG. 3 is an explanatory diagram showing a speaker unit into which is input a control signal that has been generated from a signal output from one microphone (first exemplary embodiment).

FIG. 4 is a circuit diagram showing details of a control circuit (first exemplary embodiment).

FIG. 5 is an explanatory diagram showing paths of diffracted sound of noise propagating to control points.

FIG. 6 is an explanatory diagram showing the progression of sound pressure level with time of noise at control points.

FIG. 7 is a block diagram showing a filter portion of a noise reducing device (second exemplary embodiment).

FIG. 8 is a block diagram showing a filter portion of a noise reducing device (third exemplary embodiment).

FIG. 9 (1) to (5) show example modifications showing speaker unit and microphone placement positions.

### BEST MODE OF IMPLEMENTING THE INVENTION

Explanation will be given below of details of exemplary embodiments of the present invention with reference to the drawings.

### First Exemplary Embodiment

The present exemplary embodiment is where the present invention is applied to reducing diffracted noise cut from an expressway sound barrier and propagated to the outside of the sound barrier, by using a controlled sound source (secondary sound source) placed to the outside of the sound barrier.

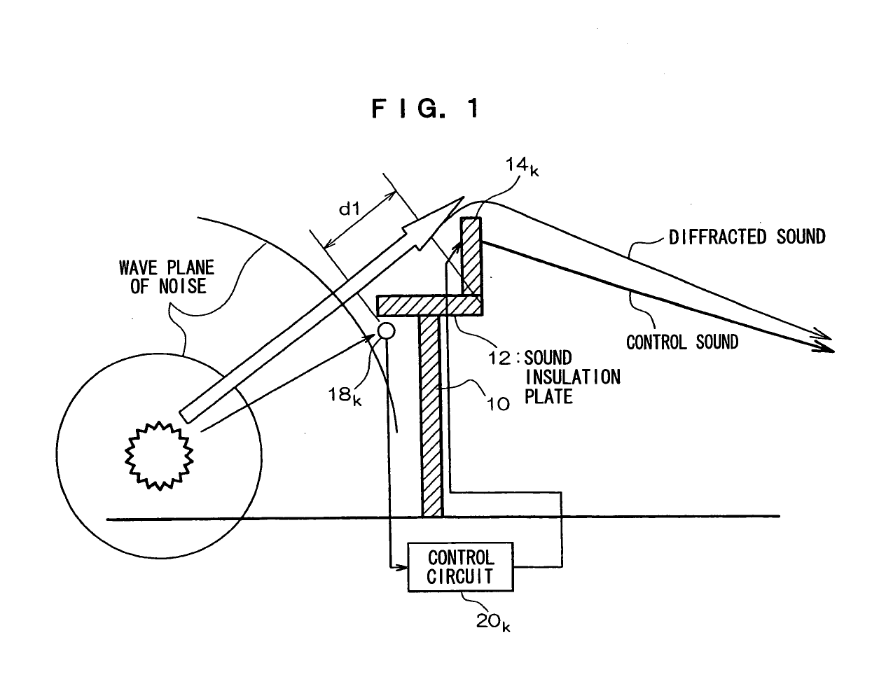

As shown in FIG. 1, there is a sound insulation plate 12 attached horizontally and continuously at the top edge of an expressway sound barrier 10 and along the top edge of the sound barrier 10. The sound insulation plate 12 contributes to preventing the generation of howling between the sensor/microphone and the controlled sound source (secondary sound source). The sound insulation plate 12 is not always necessary, and a howling prevention circuit may be introduced for controlling the generation of howling. Plural speaker units 14₁, 14₂, 14₃, . . . 14ₖ₋₁, 14ₖ, 14ₖ₊₁, . . . , 14ₙ (k and n are positive integers with k<n) are mounted at the vicinity of an edge of the sound insulation plate 12 and at the outside of the sound barrier on the top face of the sound insulation plate 12, and each of the speaker units is placed adjacently in a series. Each of the speaker units may be disposed with a predetermined interval therebetween, or may be disposed so as to be touching each other.

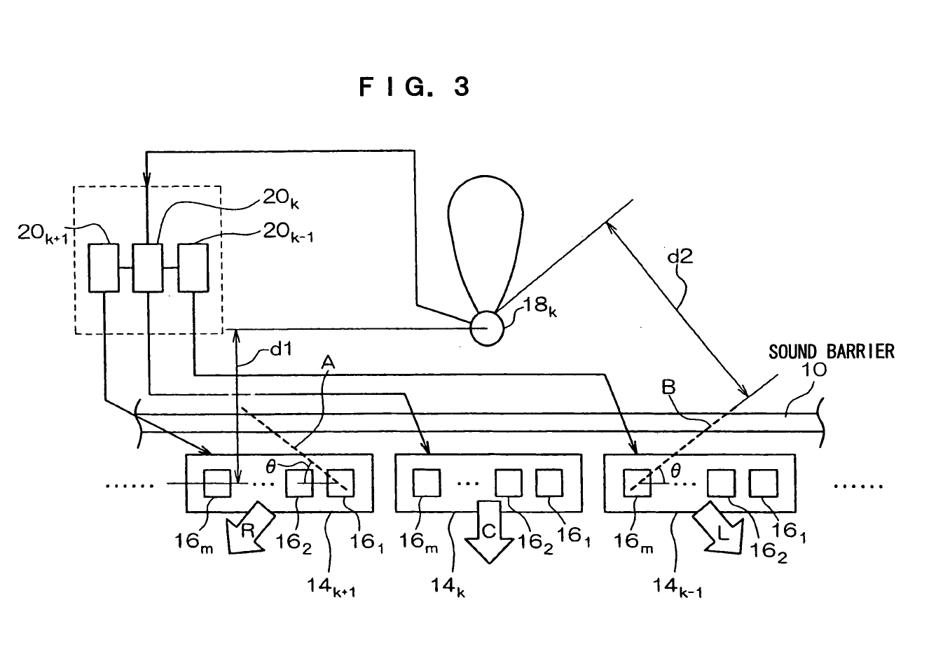

As shown in FIG. 3, each of the speaker units is configured from plural speakers 16₁, 16₂, 16₃, . . . 16ₘ that are arrayed in a straight line, arrayed so that the sound emission therefrom all face in the same direction. The sound emission direction of a single control sound emitted out from respective speakers of the present exemplary embodiment (the arrow direction allocated C, described later) is the propagation direction of the diffracted sound from the noise that has been emitted onto the front face of the sound barrier and is being diffracted, that is to say, the direction orthogonal to the array direction of the speakers, and inclined in a downward direction at an angle (see FIG. 1).

In the present exemplary embodiment, since the speaker units are arrayed in a straight line, the above sound emission directions of the speaker units are all the same direction. Meanwhile, the above sound emission directions of the speaker units are different for each of the speaker units if the sound barrier is curved and the speaker units are arranged along the sound barrier.

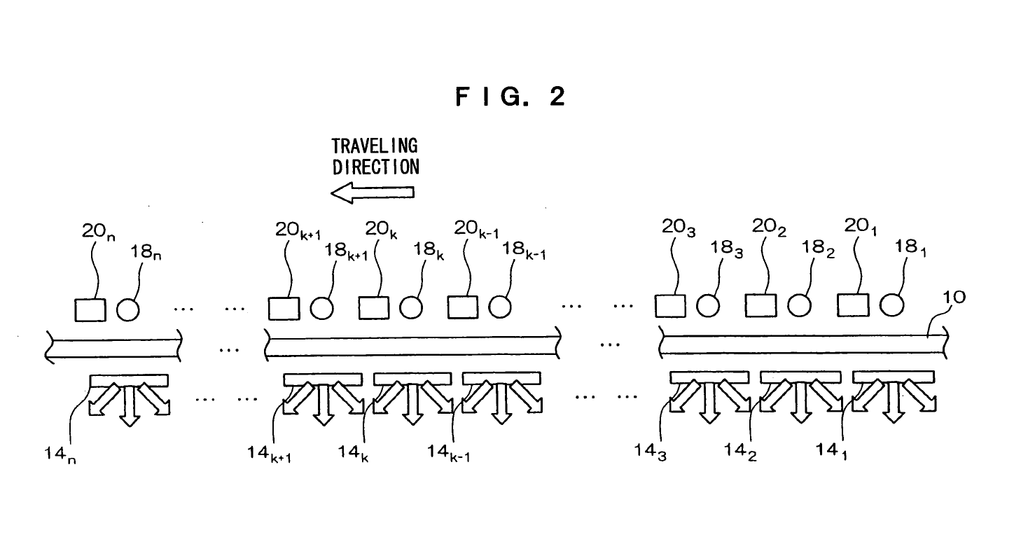

At the vicinity of an edge of the sound insulation plate 12 that is to the inside of the sound barrier and at the bottom face of the sound insulation plate 12, as shown in FIG. 1 and FIG. 2, sound of propagated noise generated at the inside of the sound barrier is collected, and there are plural microphones 18₁, 18₂, 18₃, . . . 18ₖ₋₁, 18ₖ, 18ₖ₊₁, . . . , 18ₙ, serving as sensors/microphones outputting an acoustic signal corresponding to the collected sound of the noise, provided so as to correspond to the respective speaker units. It is preferable that the positions corresponding to each of the microphones are at central portions of the speaker units. It is preferable to use ultra-directional microphones as such microphones.

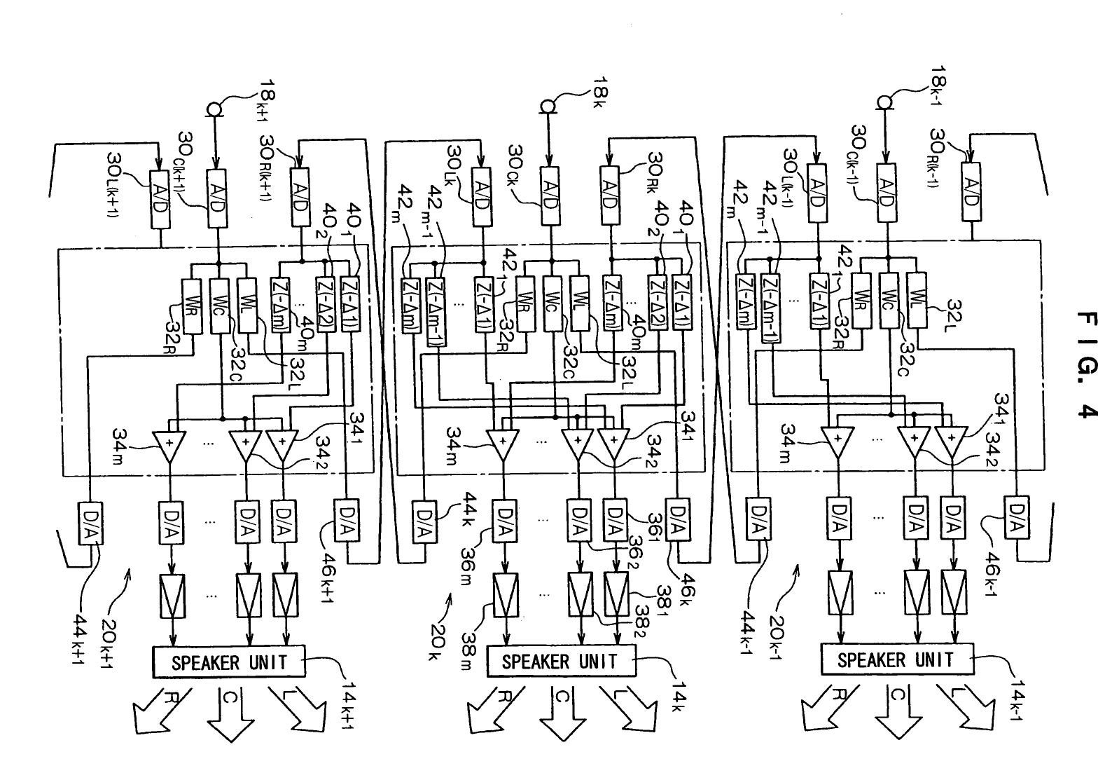

Furthermore, there are plural control circuits 20₁, 20₂, 20₃, . . . 20ₖ₋₁, 20ₖ, 20ₖ₊₁, . . . , 20ₙ that output control signals for emitting from the speaker units control sound, for reducing the sound collected at the microphone that is diffracted by the sound barrier, the control circuits 20₁, 20₂, 20₃, . . . 20ₖ₋₁, 20ₖ, 20ₖ₊₁, . . . , 20ₙ being disposed so as to correspond respectively with the plural speaker units. Such control circuits may be configured with a DSP. Respective microphones are connected at respective input terminals of the control circuits, and each respective microphone of the speaker units is connected at respective output terminals of the control circuits. Also, respective control circuits are connected to so as to input and output signals as shown in FIG. 4.

In FIG. 1 the k^{th} microphone, speaker unit, and control circuit are shown.

Next, details will be explained of the respective control circuits, with reference to FIG. 4. Since the respective control circuits are of the same configuration, explanation will be given of the k^{th} control circuit 20ₖ and explanation of the configuration of the other control circuits will be omitted. In FIG. 4 the configurations of the control circuits adjacent to the control circuit 20ₖ are drawn with some parts omitted, but the configuration thereof is the same as that of control circuit 20ₖ. As is shown in the figure, in the control circuit 20ₖ there are provided 3 analog-digital convertors (A/D convertors) 30_{Rk}, 30_{Ck} and 30_{Lk} that convert analog signals into digital signals. The microphone 18ₖ is connected to the input terminal of the analog-digital convertor 30_{Ck}.

Inverse filters 32_{R}, 32_{C} and 32_{L} are connected to the output terminal of the analog-digital convertor 30_{Ck}, and the inverse filters 32_{R}, 32_{C} and 32_{L} each carry out digital filtering using the digital signal input from the analog-digital convertor 30_{Ck} together with one or other of the filter coefficients W_{R}, W_{C} and W_{L} that have been determined in advance, and the inverse filters 32_{R}, 32_{C} and 32_{L} respectively output control signals of reverse phase relative to the digital signal input from the analog-digital convertor 30_{Ck}. In the present exemplary embodiment, the respective values of the filter coefficients W_{R}, W_{C} and W_{L} are set to be equivalent to each other, but the values may be set so as to be different from each other.

The filter coefficients W_{R}, W_{C} and W_{L} may be computed by measuring the noise in advance, and be filter coefficients for generating a control signal for emitting control sound of the opposite phase relative to the measured noise. Or, the microphone may be disposed at the control point, and in the state in which diffracted sound from the noise is propagated to the control point, the control sounds may be emitted from the respective speakers and the filter coefficients set, as the filter coefficients are adjusted of the inverse filters, as the inverse filters when the output from the microphone disposed at the control point is minimized. In both of the methods for setting the filter coefficients, control signals are generated for emitting control sounds for reducing the diffracted sound of the noise.

The output terminal of the inverse filter 32_{C} is connected to accumulators 34₁, 34₂, 34₃, . . . 34ₘ that are provided in the same number m to that of the speakers of the speaker unit and each have three inputs and one output. The respective accumulators add together the 3 input signals and output the result.

The output terminals of the accumulators 34₁, 34₂, 34₃, . . . 34ₘ are connected to the respective speakers 16₁, 16₂, 16₃, . . . 16ₘ of the speaker unit 14ₖ through digital-analog convertors (D/A convertors) 36₁, 36₂, 36₃, . . . 36ₘ for converting digital signals into analog signals, and through amplifiers 38₁, 38₂, 38₃, . . . 38ₘ for increasing the amplitude of the input signal.

The output terminal of the inverse filter 32_{L} is connected through an digital-analog convertor 46ₖ to the speaker unit 14ₖ₋₁ that is one of the adjacent speaker units to speaker unit 14ₖ so as to emit control sound in the L direction therefrom, and is connected through an analog-digital convertor (A/D convertor) 30_{L(k-1)} of a control circuit 20ₖ₋₁ corresponding to the speaker unit 14ₖ₋₁, and through delay circuits for emitting control sound in the L direction delayed by necessary delaying times Δ₁, Δ₂, Δ₃, . . . Δₘ, to the accumulators 34₁, 34₂, 34₃, . . . 34ₘ of the control circuit 20ₖ₋₁.

The output terminal of the inverse filter 32_{R} is connected through digital-analog convertor 46ₖ to the speaker unit 14ₖ₊₁ that is the other of the adjacent speaker units to speaker unit 14ₖ so as to emit control sound in the R direction therefrom, and is connected through an analog-digital convertor (A/D convertor) 30_{R(k+1)} of a control circuit 20ₖ₊₁ corresponding to the speaker unit 14ₖ₊₁, and through delay circuits for emitting control sound in the R direction delayed by necessary delay times Δ₁, Δ₂, Δ₃, . . . Δₘ, to the accumulators 34₁, 34₂, 34₃, . . . 34ₘ of the control circuit 20ₖ₊₁.

The respective control circuits of the digital-analog convertor 44ₖ, 46ₖ, and the analog-digital convertors (A/D convertors) 30_{Lk}, 30_{Rk} are not necessary if the operation of the digital signal processing of the serially disposed control circuits, of control circuit 20ₖ₋₁, control circuit 20ₖ, control circuit 20ₖ₊₁ etc., are operated according to the same master clock. In such a case each of the control circuits are connected directly, and not through a digital-analog convertor and an analog-digital convertor.

Therefore, FIG. 4 is an example in which all of the serially disposed control circuits control circuit 20ₖ₋₁, control circuit 20ₖ, control circuit 20ₖ₊₁ etc. have their own respective independent master clocks.

The output terminal of the analog-digital convertor 30_{Rk} is connected to respective delay elements 40₁, 40₂, 40₃, . . . 40ₘ that are provided to a delay circuit in the same number m to the number of the speakers of the speaker unit and that delay input singles with respective incremental delay times of Δ₁, Δ₂, Δ₃, . . . Δₘ. The delay times of Δ₁, Δ₂, Δ₃, . . . Δₘ may be, for example, set to 0, τ, 2τ, . . . (m−1)τ.

The output terminal of the analog-digital convertor 30_{Lk} is connected to respective delay elements 42₁, 42₂, 42₃, . . . 42ₘ that are provided to a delay circuit in the same number m to the number of the speakers of the speaker units and that delay input singles with respective incremental delay times of Δ₁, Δ₂, Δ₃, . . . Δₘ. The delay times of Δ₁, Δ₂, Δ₃, . . . Δₘ may be, for example, set to 0, τ, 2τ, . . . (m−1)τ.

Respective delay elements 40₁, 40₂, 40₃, . . . 40ₘ are connected to the input terminals of the respective accumulators 34₁, 34₂, 34₃, . . . 34ₘ. By doing so, delayed control signals are input, through the adding circuits, the digital-analog convertors, and the amplifiers, in sequence to each of the speakers of the speaker units from the speaker at one end of the speaker units toward the speaker at the other end thereof, from the signal with the smallest delay time to the signal with the largest delay time, with the delay times gradually getting longer.

Also, respective delay elements 42₁, 42₂, 42₃, . . . 42ₘ are connected to inputs of the accumulators 34₁, 34₂, 34₃, . . . 34ₘ in the opposite manner to the connection of the delay elements 40₁, 40₂, 40₃, . . . 40ₘ to the accumulators. That is to say, the respective delay elements 42₁, 42₂, 42₃, . . . 42ₘ are connected such that the accumulator that has been input with the delayed control signal output with the smallest delay time output from the delay elements 40₁, 40₂, 40₃, . . . 40ₘ, is input with the control signal with the largest delay time, and the accumulator that has been input with the delayed control signal output with the largest delay time output from the delay elements 40₁, 40₂, 40₃, . . . 40ₘ, is input with the control signal with the smallest delay time.

By doing so, delayed control signals are input, through the adding circuits, the digital-analog convertors, and the amplifiers, in sequence to each of the speakers of the speaker units from the speaker at the one end of the speaker units toward the speaker at the other end thereof, from the signal with the largest delay time to the signal with the smallest delay time with the delay times gradually getting shorter.

As a result of configuring each of the control circuits as above, as shown in FIG. 3, an acoustic signal that has been output from one microphone 18ₖ is input to the speaker unit 14ₖ through the control circuit 20ₖ, and also input to speaker unit 14ₖ₋₁ through control circuit 20ₖ and control circuit 20ₖ₋₁, corresponding to speaker unit 14ₖ₋₁ that is one of the speaker units adjacent to speaker unit 14ₖ, and input to speaker unit 14ₖ₊₁ through control circuit 20ₖ and control circuit 20ₖ₊₁, corresponding to speaker unit 14ₖ₊₁ that is the other of the speaker units adjacent to speaker unit 14ₖ.

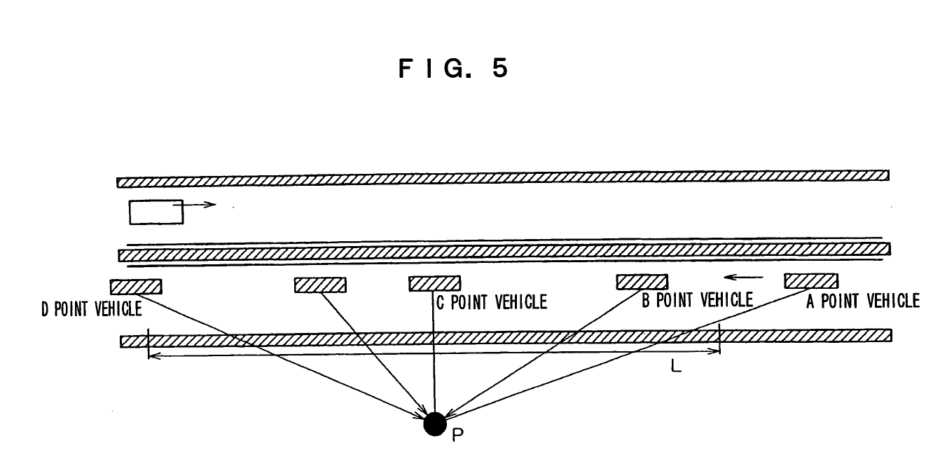

Next, explanation will be given of the operation of the present exemplary embodiment. As shown in FIG. 5, if the control point for reducing the noise is P, then a portion of the noise that is emitted due to vehicles travelling on the expressway is blocked by the sound barrier, but other portions of the noise are diffracted by the top edge side of the sound barrier, and the diffracted sound is propagated to the control point P from directions of straight ahead and from both the left and right directions.

Noise that is generated by vehicles travelling on the expressway is collected at respective microphones, and acoustic signals corresponding to the noise that has been collected from respective microphones is output, converted into digital signals by the respective analog-digital convertors that are connected to the microphones, and input to the respective inverse filters. In the respective inverse filters, digital filtering is carried out using the digital signal that has been input and the filter coefficients that have been set in advance, and a control signal is generated and output that is of the reverse phase relative to the digital signal that has been input from the analog-digital convertor.

Next, explanation will be given of the operation of each of the control circuits in FIG. 4 using the control circuit 20ₖ as representative thereof. In the control circuit 20ₖ the control signal that has been output from the inverse filter 32_{C} is simultaneously input to the respective accumulators 34₁, 34₂, 34₃, . . . 34ₘ, converted into analog signals by the respective digital-analog convertors 36₁, 36₂, 36₃, . . . 36ₘ, and simultaneously input to the respective speakers of speaker unit 14ₖ via the respective amplifiers 38₁, 38₂, 38₃, . . . 38ₘ. By doing so, control sound is emitted from the speaker unit in a direction that is orthogonal to the direction in which the speakers are arrayed in the speaker units and in a direction that is inclined downward (in the arrow direction designated with C) and the diffracted sound of the noise propagated in the arrow direction designated C is reduced at the control point. Here, the plane of the combined waves of the control sound is parallel to the array direction of the speakers in the speaker unit.

Furthermore, the control signal that has been output from the inverse filter 32_{R} of the control circuit 20ₖ₋₁ is input to the delay circuit through the digital-analog convertor 44ₖ₋₁ and the analog-digital convertor 30_{Rk} of the control circuit 20ₖ, it is delayed by the respective incremental delay times of Δ₁, Δ₂, Δ₃, . . . Aₘ, and input to the respective accumulators 34₁, 34₂, 34₃, . . . 34ₘ. Here, the respective control signals that have been delayed (delayed control signals) are input into the respective accumulators 34₁, 34₂, 34₃, . . . 34ₘ in the sequence from the shortest delay time. The delayed control signals that have been output from the accumulators 34₁, 34₂, 34₃, . . . 34ₘ are converted into analog signals by the respective digital-analog convertors 36₁, 36₂, 36₃, . . . 36ₘ, and input into the respective speakers of the speaker unit 14ₖ via the respective amplifiers 38₁, 38₂, 38₃, . . . 38ₘ. By doing so, each of the speakers of the speaker unit are input with respective delayed control signals so that the delay time gradually gets longer from the speaker at the one end of the speaker unit toward the speaker at the other end. By doing so the control sound that is emitted from each of the speakers is combined, and the plane of the combined wave is formed in a direction that is inclined at an angle θ, shown in the formula below, relative to the arrayed direction of the speakers of the speaker units, and the control sound is emitted in the arrow direction designated with R. Thus, since the control sound emitted which has been inclined at angle θ becomes equivalent to that from the hypothetical sound source A (see FIG. 3), the diffracted sound of the noise propagating in the arrow direction designated by R is reduced at the control point.

[Equation 1]

θ=sin⁻¹{(Δₘ−Δ₁)c/D} (1)

Wherein in the above, c is the speed of sound of the control sound, D is the length of the speaker unit in the speaker array direction, and θ is positive in the clockwise direction with reference to the speaker array direction.

Furthermore the signal output from the inverse filter 32_{L} of the control circuit 20ₖ₋₁ is input into the delay circuit through the digital-analog convertor 46ₖ and the analog-digital convertor 30_{Ck} of the control circuit 20ₖ, delayed by respective incremental delay times of Δ₁, Δ₂, Δ₃, . . . Δₘ, and input to the respective accumulators 34₁, 34₂, 34₃, . . . 34ₘ. Here, the respective delayed control signals are input into the respective accumulators 34₁, 34₂, 34₃, . . . 34ₘ in the sequence from the longest delay time, the reverse order to the above. The delayed control signals that have been output from the accumulators 34₁, 34₂, 34₃, . . . 34ₘ are converted into analog signals by the respective digital-analog convertors 36₁, 36₂, 36₃, . . . 36ₘ, and input into the respective speakers of the speaker unit 14ₖ through the respective amplifiers 38₁, 38₂, 38₃, . . . 38ₘ. By so doing, delayed control signals are input into each of the speakers of the speaker units with gradually shortening delay times from the speaker at the one end to the speaker at the other end. Thereby, the sound emitted from each of the speakers is combined into a control sound, with a combined wave front formed at an inclination angle of (π−θ) to the array direction of the speakers in the speaker units, and the control sound is emitted in the direction of the arrow allocated letter L. Therefore, the diffracted sound of the noise propagating in the direction of the arrow allocated the letter L is reduced at the control point since the control sound emitted at an inclination angle of (π−θ) is equivalent to that from the hypothetical sound source B (see FIG. 3).

If the distance from the microphone 18ₖ to the speaker unit 14ₖ is d1, and the distance to the hypothetical sound source A formed by the speaker unit 14ₖ₊₁ and to the hypothetical sound source B formed by the speaker unit 14ₖ₋₁ is d2, and the respective processing time of the control circuits are T (processing time is set to be approximately equivalent to an excess of the time to pass through the analog-digital convertor and digital-analog convertor, for forming the hypothetical sound source), and, since d1<d2, it is preferable that the control circuit processing time is determined so as to satisfy the following equation.

[Equation]

d1/c>T (2)

Since control sound is emitted from each of the respective speaker units, as explained above, in the direction of the arrow allocated letter R, the direction of the arrow allocated letter C, and the direction of the arrow allocated letter L, the diffracted sound is reduced of the noise that is propagating to the front, and to the left and the right of the control point.

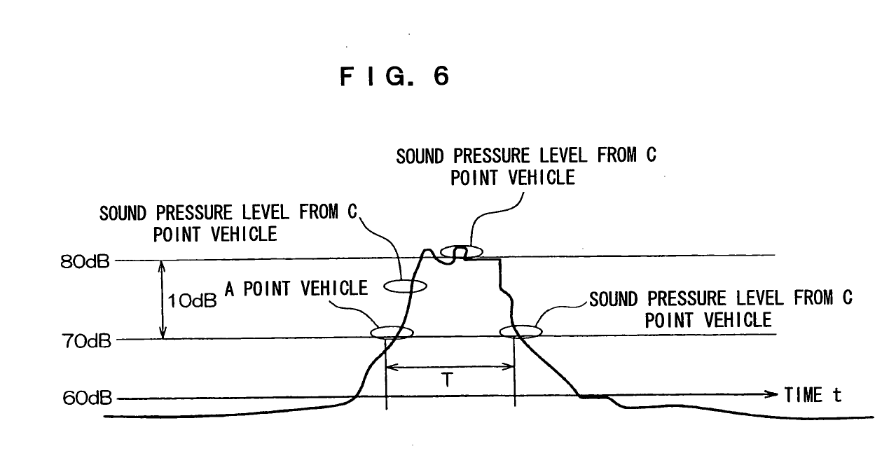

Explanation will next be given regarding the lengths of the control sections that are able to reduce the noise in the present exemplary embodiment. As shown in FIG. 5, noise that is generated from the point A to the point D by vehicles travelling in the direction of the arrow on the expressway, and that moves with the vehicles as they travel, is diffracted by the sound barrier and propagates to the control point P from the respective directions of the front, left and right. Therefore, the noise level is highest from the point C that is the closest to the control point, and the noise level is lowest from the points A and D that are the furthest from the control point. When considering the reduction of a noise level that is at a prescribed sound pressure level (for example, 70 dB) or above, that is to say the total noise level generated from the point A to point D, for the time that the noise level continues at the prescribed sound pressure level or above to be T(seconds), in the example of the change in the noise sound pressure level at the control point with time in FIG. 6, if the velocity of the vehicle is V [km/h], then the length L [m] of the control section that is able to reduce the noise at the control point P is as set out below.

[Equation 3]

L=V×T/(1000×60×60) (3)

### Second Exemplary Embodiment

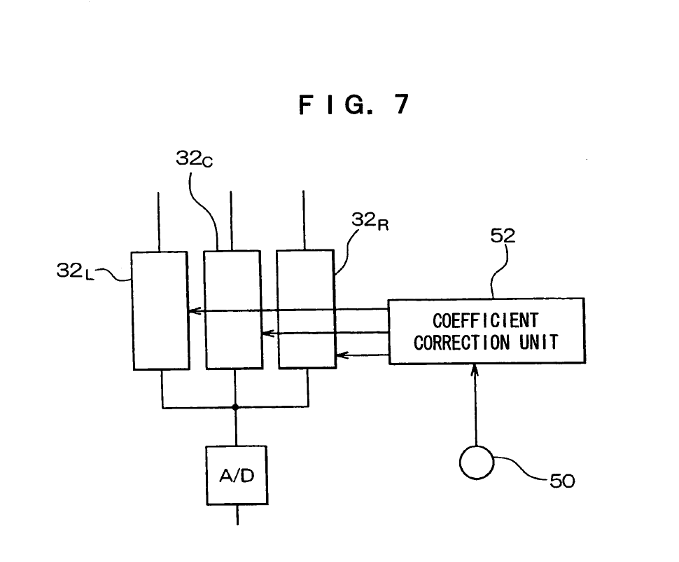

Explanation will next be given of a second exemplary embodiment of the present invention with reference to FIG. 7. In the present exemplary embodiment, there is an external air temperature sensor 50 disposed therein for detecting the external air temperature, a coefficient correction unit 52 is provided to each of the control circuits, and correction is carried out in the coefficient correction unit 52 using respective filter coefficients according to the external air temperature. The correction coefficients for correcting the filter coefficients according to the external air temperature are stored in advance in the respective coefficient correction units 52, and the coefficient correction units 52 read out the correction coefficients according to the external air temperature that has been detected and carry out correction of the filter coefficients of the inverse filters.

By so doing, the diffracted sound of the noise may be effectively reduced even if the speed of sound has changed due to the external air temperature.

An external air temperature sensor may be provided to correspond to each of the respective control circuits, or one of the external air temperature sensors may be disposed for each group of plural control circuits in single groups, or a single external air temperature sensor may be provided for a single noise reducing device.

### Third Exemplary Embodiment

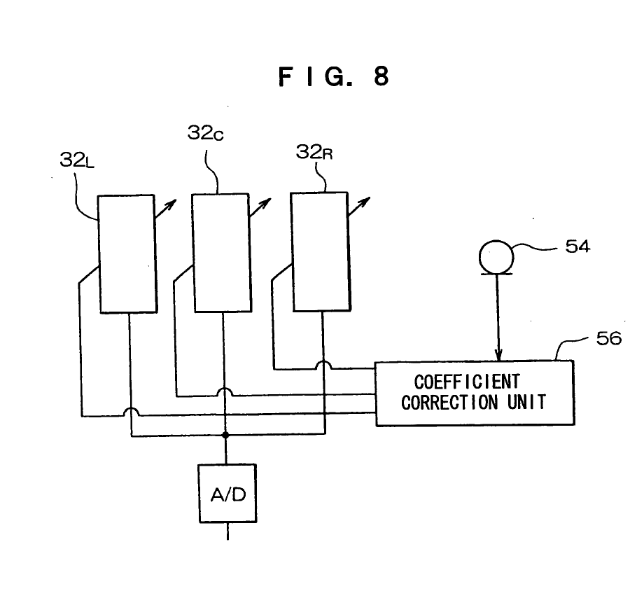

The third exemplary embodiment uses adaptive filters for the inverse filters 32_{R}, 32_{C} and 32_{L}, as shown in FIG. 8, a microphone 54 is arranged for detecting at the control point P the signal error between the control sound and the diffracted sound of the noise, and correction is carried out of the filter coefficients of the adaptive filters so that the signal error of a coefficient correction device is as small as possible.

In doing so, the diffracted sound of the noise may be effectively reduced even if there is a change in the environment, since control may be carried out so that the signal error between the control sound and the diffracted sound of the noise is as small as possible.

In the above exemplary embodiments, explanation was given of a case in which the diffracted sound of the noise is reduced, however, the present invention is applicable to reducing the direct noise that is propagated to control points without diffraction. In such a case, control sound is emitted in the direction of propagation of the direction sound of the noise, or in a direction that intersects with the direction of the direct sound of the noise. Furthermore, explanation was given above of a case in which control sound is emitted in three directions, however, control sound may be emitted in two directions, and whereas explanation was given of a case in which plural individual speaker units where provided, if the region for reduction of the noise is narrow, a single speaker unit and plural microphones may be provided.

Explanation will next be given of example modifications to the mounting positions of the speaker units and the microphones. Explanation was given above of an example in which speaker units are mounted in the vicinity of the outside edge on the top face of a sound insulation plate that is mounted horizontally to the top edge of a sound barrier, and microphones are mounted to the bottom face of the sound insulation plate, however, speaker units and microphones may be mounted as described below. Here, explanation will be given with respect to a single speaker unit and a microphone corresponding to this speaker unit and, since the other speaker units and microphones are similar, explanation thereof is omitted.

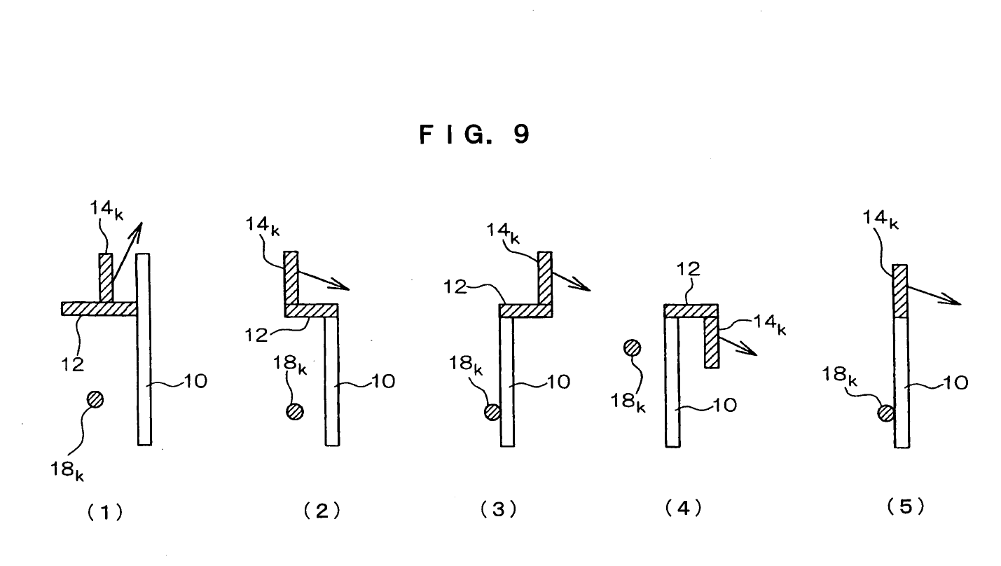

In the modification example in FIG. 9 (1), a sound insulation plate 12 is mounted horizontally to the inside surface of the barrier at the top edge side of a sound barrier 10, and a speaker unit 14ₖ is mounted to the top face of the sound insulation plate 12 at substantially a central portion thereof, and a microphone 18ₖ is disposed in a position that is separated from the sound barrier at the lower side of the speaker unit and on the inside of the sound barrier. This modification example is favorably applied to reducing the direct sound of a noise, since the control sound is emitted inclined in an upward direction.

In the modification example in FIG. 9 (2), one side of a sound insulation plate 12 is fixed to the top edge of a sound barrier 10, and the sound insulation plate 12 is mounted horizontally to as to extend out to the inside of the sound barrier, and a speaker unit 14ₖ is mounted to the top face of the sound insulation plate 12 at the side thereof that is opposite to the side that is fixed to the sound barrier 10, and a microphone 18ₖ is disposed in a position that is separated from the sound barrier at the lower side of the speaker unit and on the inside of the sound barrier.

In the modification example in FIG. 9 (3), one side of a sound insulation plate 12 is fixed to the top edge of a sound barrier 10, and the sound insulation plate 12 is mounted horizontally to as to extend out to the outside of the sound barrier, and a speaker unit 14ₖ is mounted to the top face of the sound insulation plate 12 at the side that is opposite to the side that is fixed to the sound barrier 10, and a microphone 18ₖ is disposed at the internal face of the sound barrier at the lower side thereof.

The modification example in FIG. 9 (4) has a sound insulation plate 12 fixed in a similar manner to that of the modification example of FIG. 9 (3), with a speaker unit 14ₖ is mounted to the bottom face of the sound insulation plate 12 at the side thereof that is opposite to the side that is fixed to the sound barrier 10, and a microphone 18ₖ is disposed in a position that is separated from the upper internal face of the sound barrier to the inside thereof.

The modification example in FIG. 9 (5) does not use a sound insulation plate, and mounts a speaker unit 14ₖ along the top edge of a sound barrier, and a microphone 18ₖ is disposed at the lower internal face of the sound barrier.

### INDUSTRIAL APPLICABILITY

Other than the reductions that may be made to noise generated from expressways, as explained above, reductions may also be made of noise generated when moving bodies are moved such as in a railway, and furthermore, reductions may be made in the generation of noise from a stationary noise source.

### EXPLANATION OF THE REFERENCE NUMERALS

10 sound barrier
12 sound insulation plate
14₁, 14₂, 14₃, . . . 14ₙ speaker units
16₁, 16₂, 16₃, . . . 16ₘ speakers
18₁, 18₂, 18₃, . . . 18ₙ microphones
20₁, 20₂, 20₃, . . . 20ₙ control circuits
32_{R}, 32_{c}, 32_{L} inverse filters
34₁, 34₂, 34₃, . . . 34ₘ accumulators

1. A noise reducing device comprising:
a speaker unit comprising a plurality of speakers arrayed so that the direction of sound emission therefrom faces in a predetermined direction;
a first microphone, disposed so as to correspond to the speaker unit, and collecting the sound of a noise and outputting a first acoustic signal corresponding to the sound of the noise that has been collected;
a second microphone, disposed in a position that is separated in the speaker array direction from the disposed position of the first microphone, and collecting the sound of a noise and outputting a second acoustic signal corresponding to the sound of the noise that has been collected;
first control signal output means that outputs, on the basis of the first acoustic signal, a first control signal for emitting a control sound that reduces the direct sound or the diffracted sound of the noise that has been collected by the first microphone;
second control signal output means that outputs, on the basis of the second acoustic signal, a plurality of second control signals for emitting a control sound that reduces the direct sound or the diffracted sound of the noise that has been collected by the second microphone, the plurality of second control signals having each been delayed respectively by incremental predetermined time periods; and
control means, controlling such that the first control signal is input simultaneously to the respective speakers, and such that the second control signals are input with gradually increasing delay times from the speaker at one end of the speaker unit toward the speaker at the other end of the speaker unit.

2. The noise reducing device of claim 1, wherein the control means comprises a plurality of accumulators that add together the first signal and one of the second control signals, and input the result of the addition to the respective speakers of the speaker unit.

3. The noise reducing device of claim 1, wherein the second control signal output means comprises:
output means, outputting, based on the second acoustic signal, a control signal that is of opposite phase to the noise that has been collected by the second microphone; and
delay means, delaying a plurality of times the opposite phase control signal respectively by predetermined incremental periods of time and outputting a plurality of second control signals.

4. A noise reducing device comprising:
a speaker unit comprising a plurality of speakers arrayed so that the direction of sound emission therefrom faces in a predetermined direction;
a first microphone, disposed so as to correspond to the speaker unit, and collecting the sound of a noise and outputting a first acoustic signal corresponding to the sound of the noise that has been collected;
a second microphone, disposed in a position that is separated in the speaker array direction from the disposed position of the first microphone, and collecting the sound of a noise and outputting a second acoustic signal corresponding to the sound of the noise that has been collected;
a third microphone, disposed in a position that is separated in the speaker array direction from the disposed position of the first microphone in the opposite direction to that of the third microphone, and collecting the sound of a noise and outputting a third acoustic signal corresponding to the sound of the noise that has been collected;
first control signal output means that outputs, on the basis of the first acoustic signal, a first control signal for emitting a control sound that reduces the direct sound or the diffracted sound of the noise that has been collected by the first microphone;
second control signal output means that outputs, on the basis of the second acoustic signal, a plurality of second control signals for emitting a control sound that reduces the direct sound or the diffracted sound of the noise that has been collected by the second microphone, the plurality of second control signals having each been delayed respectively by incremental predetermined time periods;
third control signal output means that outputs, on the basis of the second acoustic signal, a plurality of third control signals for emitting a control sound that reduces the direct sound or the diffracted sound of the noise that has been collected by the third microphone, the plurality of third control signals having each been delayed respectively by incremental predetermined time periods; and
control means, controlling such that the first control signal is input simultaneously to the respective speakers, such that the second control signals are input with gradually increasing delay times from the speaker at one end of the speaker unit toward the speaker at the other end of the speaker unit, and such that the third control signals are input with gradually decreasing delay times from the speaker at the one end of the speaker unit toward the speaker at the other end of the speaker unit.

5. The noise reducing device of claim 4, wherein the second control signal output means comprises:
output means, outputting, based on the second acoustic signal, a control signal that is of opposite phase to the noise that has been collected by the second microphone; and
delay means, delaying a plurality of times the opposite phase control signal respectively by predetermined incremental periods of time and outputting a plurality of second control signals; and the third control signal output means comprises:
output means, outputting, based on the third acoustic signal, a control signal that is of opposite phase to the noise that has been collected by the third microphone; and
delay means, delaying a plurality of times the opposite phase control signal respectively by predetermined incremental periods of time and outputting a plurality of third control signals.

6. A noise reducing device comprising:
a plurality of speaker units each comprising a plurality of speakers arrayed so that the direction of sound emission therefrom faces in a predetermined direction;
a plurality of microphones, disposed so as to correspond to the respective speaker units, and collecting the sound of a noise and outputting an acoustic signal corresponding to the sound of the noise that has been collected;
first control signal output means provided to correspond with each of the respective speaker units, and that output, on the basis of the acoustic signal that has been output from a first corresponding microphone that corresponds to the corresponding speaker unit, a first control signal for emitting a control sound that reduces the direct sound or the diffracted sound of the noise that has been collected by the first corresponding microphone;
second control signal output means provided to correspond with each of the respective speaker units, and that output, on the basis of the acoustic signal that has been output from a second corresponding microphone that corresponds to one of the speaker units that is adjacent to the corresponding speaker unit, a second control signal for emitting a control sound that reduces the direct sound or the diffracted sound of the noise that has been collected by the second corresponding microphone;
third control signal output means provided to correspond with each of the respective speaker units, and that output, on the basis of the acoustic signal that has been output from a third corresponding microphone that corresponds to the other one of the speaker units that is adjacent to the corresponding speaker unit, a third control signal for emitting a control sound that reduces the direct sound or the diffracted sound of the noise that has been collected by the third corresponding microphone; and
control means, provided so as to input the signals to the respective speaker units, and controlling such that the first control signal is input simultaneously to the respective speakers of the speaker units to which the signals are being input, such that the respective second control signals are input to the speakers of the speaker unit to which the signals are being input with gradually increasing delay times from the speaker at one end of the speaker unit to which the signals are being input toward the speaker at the other end thereof, and such that the third respective control signals are input to the speakers of the speaker unit to which the signals are being input with gradually decreasing delay times from the speaker at the one end of the speaker unit to which the signals are being input toward the speaker at the other end thereof.

7. The noise reducing device of claim 4, wherein the control means comprises a plurality of accumulators that add together the first signal, one of the second control signals and one of the third control signal, and inputs the result of the addition to the respective speakers of the speaker unit.

8. The noise reducing device of claim 4, wherein the second control signal output means comprises:
output means, outputting, based on the acoustic signal that has been output from the second microphone, a control signal that is of opposite phase to the noise that has been collected by the second microphone; and
delay means, delaying a plurality of times the opposite phase control signal respectively by predetermined incremental periods of time and outputting a plurality of second control signals, and the third control signal output means comprises:
output means, outputting, based on the acoustic signal that has been output from the third microphone, a control signal that is of opposite phase to the noise that has been collected by the third microphone; and
delay means, delaying a plurality of times the opposite phase control signal respectively by predetermined incremental periods of time and outputting a plurality of third control signals.

9. The noise reducing device of claim 1, wherein the speaker unit(s) is/are disposed at the upper side of the top edge of a sound barrier, or disposed at the outside of the upper edge side of a sound barrier, and disposed so that the predetermined direction faces the propagation direction of the direct sound or propagation direction of the diffracted sound from a noise.

10. The noise reducing device of claim 1, wherein the control signal is corrected according to the external air temperature.

11. The noise reducing device of claim 1, further comprising detection means, detecting an error signal at a control point between the control sound and direct sound of a noise, or detecting an error signal at a control point between the control sound and diffracted sound of a noise, and wherein the control signal is corrected so that the error signal becomes small by the control signal output means.

12. The noise reducing device of claim 6, wherein the control means comprises a plurality of accumulators that add together the first signal, one of the second control signals and one of the third control signal, and inputs the result of the addition to the respective speakers of the speaker unit.

13. The noise reducing device of claim 6, wherein the second control signal output means comprises:
output means, outputting, based on the acoustic signal that has been output from the second microphone, a control signal that is of opposite phase to the noise that has been collected by the second microphone; and
delay means, delaying a plurality of times the opposite phase control signal respectively by predetermined incremental periods of time and outputting a plurality of second control signals, and the third control signal output means comprises:
output means, outputting, based on the acoustic signal that has been output from the third microphone, a control signal that is of opposite phase to the noise that has been collected by the third microphone; and
delay means, delaying a plurality of times the opposite phase control signal respectively by predetermined incremental periods of time and outputting a plurality of third control signals.

14. The noise reducing device of claim 4, wherein the speaker unit(s) is/are disposed at the upper side of the top edge of a sound barrier, or disposed at the outside of the upper edge side of a sound barrier, and disposed so that the predetermined direction faces the propagation direction of the direct sound or propagation direction of the diffracted sound from a noise.

15. The noise reducing device of claim 6, wherein the speaker unit(s) is/are disposed at the upper side of the top edge of a sound barrier, or disposed at the outside of the upper edge side of a sound barrier, and disposed so that the predetermined direction faces the propagation direction of the direct sound or propagation direction of the diffracted sound from a noise.

16. The noise reducing device of claim 4, wherein the control signal is corrected according to the external air temperature.

17. The noise reducing device of claim 6, wherein the control signal is corrected according to the external air temperature.

18. The noise reducing device of claim 4, further comprising detection means, detecting an error signal at a control point between the control sound and direct sound of a noise, or detecting an error signal at a control point between the control sound and diffracted sound of a noise, and wherein the control signal is corrected so that the error signal becomes small by the control signal output means.

19. The noise reducing device of claim 6, further comprising detection means, detecting an error signal at a control point between the control sound and direct sound of a noise, or detecting an error signal at a control point between the control sound and diffracted sound of a noise, and wherein the control signal is corrected so that the error signal becomes small by the control signal output means.
